(19) United States
(12) Patent Application Publication
(10) Pub. No.: US 2017/0177406 A1
(43) Pub. Date: Jun. 22, 2017

(54) METHODS FOR MANAGING A SERVICE OR APPLICATION FOR A SMART DEVICE AND A SMART DEVICE UTILIZING THE SAME

(71) Applicant: MediaTek Singapore Pte. Ltd., Singapore (SG)

(72) Inventors: Wen-bin CHEN, Shenzhen City (CN); Chin-Wen CHANG, Taichung City (TW); Xianggao KONG, Shenzhen City (CN); Ching-Ho CHAN, Taoyuan City (TW)

(21) Appl. No.: 15/354,106

(22) Filed: Nov. 17, 2016

(30) Foreign Application Priority Data
Dec. 18, 2015 (CN) 201510964915.9

(51) Int. Cl. G06F 9/48; G06F 11/34; G06F 11/30

(52) U.S. Cl. CPC G06F 9/4831; G06F 11/302; G06F 11/3013; G06F 11/3442

(57) ABSTRACT

A method for managing a service or application for a smart device includes: obtaining a priority corresponding to the service or application according to a priority table; adjusting or terminating the service or application according to the priority; monitoring the service or application in real-time to obtain a monitoring result; and updating the priority table according to the monitoring result.

### CROSS REFERENCE TO RELATED APPLICATIONS

This Application claims priority of China Patent Application No. 201510964915.9, filed on Dec. 18, 2015, the entirety of which is incorporated by reference herein.

### BACKGROUND OF THE INVENTION

Field of the Invention

The invention relates to smart devices, and more particularly to a smart device and a method for managing the smart device's application or service.

Description of the Related Art

As technology has developed, smart devices have become increasingly popular in people's daily lives. Currently, it takes long time to start up services and applications of a smart device after the smart device (such as Android smartphone) has been in use for a period of time.

Specifically, some services and applications used by a smart device request too many permissions, especially permissions to auto-start after each system boot up and permissions of the guard program, resulting in occupying the runtime memory space of the smart device after booting, and thereby the time required for the smart device to start up the service or the application gets longer and longer.

### BRIEF SUMMARY OF THE INVENTION

Methods for managing a service or application for a smart device and a smart device are provided. An exemplary embodiment of a method for managing a service or application for a smart device comprises: obtaining a priority corresponding to the service or application according to a priority table; adjusting or terminating the service or application according to the priority; monitoring the service or application in real-time to obtain a monitoring result; and updating the priority table according to the monitoring result.

An exemplary embodiment of a smart device is provided. The smart device includes a storage module, a processor module, and a monitoring module. The storage module stores a priority table for services or applications. The processor module is coupled to the storage module, obtains the priority of a service or application according to the priority table, and adjusts or terminates the service or application according to the priority. The monitoring module is coupled to the storage module. The monitoring module monitors the service or application in real-time to obtain a monitoring result and updates the priority table according to the monitoring result.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a flow chart of a method for managing services or applications according to a first embodiment of the invention; and

FIG. 2 shows a block diagram of a smart device according to the first embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

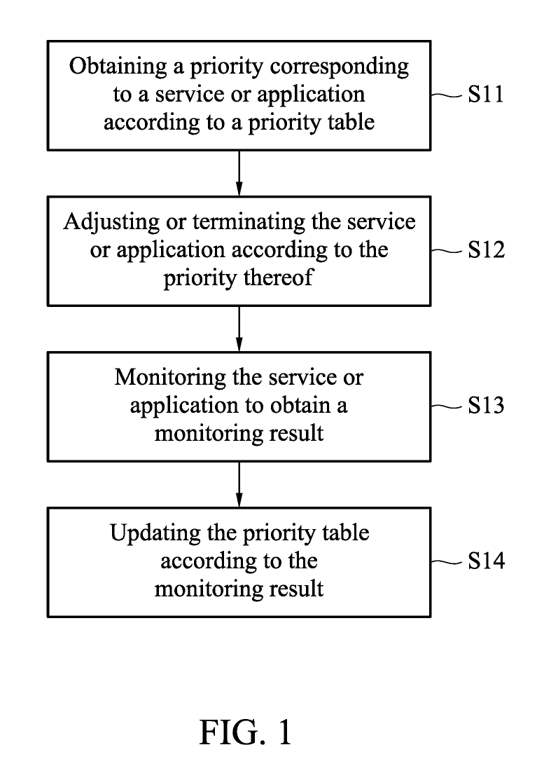

Referring to FIG. 1, FIG. 1 is a flow chart of a method for managing services or applications according to a first embodiment of the invention. The method for managing services or applications in this embodiment may be applied to smart devices. The smart devices may be smart phones or tablet computers. As shown in FIG. 1, the steps of the method for managing services or applications comprise:

Step S11: Obtaining a priority corresponding to a service or application according to a priority table.

When the smart device is powered up, the smart device obtains the priority table and obtains a priority corresponding to a service or application according to the priority table. For example, the service or application of a smart device may comprise a phonebook, a chat application and a game application. The smart device obtains the priorities corresponding to the phonebook, the chat application and the game application according to the priority table, and the priorities thereof ranked from high to low are the priority of the phonebook, the priority of the chat application and the priority of the game application.

In addition, after the smart device is started-up, when the smart device notices that the priority table is updated, the step S11 is entered.

Step S12: Adjusting or terminating the service or application according to the priority thereof.

The smart device adjusts or terminates a service or application according to the corresponding priority. That is, when the priority of the service or application changes, the smart device may adjust or terminate the service or application. For example, when the game application had a high priority before and has a low priority now, the smart device may terminate the game application to decrease the requirement of the runtime memory space.

Preferably, a predetermined value may be set. When the priority of the service or application is lower than the predetermined value, the smart device adjusts the service or the application to auto-start limited. For example, the priorities may be represented by values. A lower priority corresponds to a higher value. The predetermined value is set to 20. When the priority of a service or application is 30, the priority of the service or application is lower than the predetermined value, and the smart device adjusts the service or the application to auto-start limited.

In addition, when the amount of runtime memory space occupied by the started-up service(s) or application(s) exceeds a threshold value, the smart device terminates the low priority service or application among the started-up service(s) or application(s). For example, suppose that the predetermined threshold value is 90%. When the amount of runtime memory space occupied by the started-up services or applications is 95%, it means that the amount of runtime memory space occupied by the started-up service or application exceeds the threshold value and the smart device terminates the low priority service or application among the started-up services or applications.

Step S13: Monitoring the service or application to obtain a monitoring result;

The smart device monitors the service or application in real-time to obtain the monitoring result. The smart device monitors the service or application in real-time according to the monitoring condition predefined by the user or the default factory setting. For example, the smart device may monitor the service or application according to the frequency with which the service or application is started-up.

Step S14: Updating the priority table according to the monitoring result.

The smart device may update the priority table according to the monitoring result. Specifically, the smart device may update the priority table according to the monitoring result when the monitoring result changes and may keep monitoring the service or application when the monitoring result remains unchanged.

For example, when the monitoring result shows that the frequency of the service or application being started-up is higher than a first predetermined value, the smart device may increase the priority of the service or application and updates the priority table.

In addition, after the smart device updates the priority table, the smart device may repeat the operations in steps S11 to S14.

In the embodiments of the invention, the smart device may obtain the corresponding priority of the service or application according to the priority table; adjust or terminate the service or application according to the priority thereof; monitor the service or application in real-time to obtain a monitoring result; and update the priority table according to the monitoring result. The smart device may achieve self-learning by observing the actual operation of the user. The smart device may monitor the service or application in real-time to obtain a monitoring result; update the priority table according to the monitoring result; and adjust or terminate the service or application according to the updated priority to prevent the time taken for the smart device to start up the service or the application from getting longer and longer and improve the performance of the smart device and increase the amount of saved-power of the smart device.

In a second embodiment of the invention, another method for managing services or applications, which was developed based on the method for managing services or applications in the first embodiment, is provided. Specifically, in step S13, the smart device monitors the service or application in real-time according to a factor (monitoring condition) predefined by the user to obtain the monitoring result. In other embodiments, it will be readily appreciated by those who are skilled in this technology that there may be multiple factors predefined according to the requirements for monitoring the service or application in real-time.

The smart device may monitor the service or application in real-time according to a first factor: the smart device identifies whether the service or application is started-up by a user. When the amount of runtime memory space occupied by the service or application that is not started-up by a user exceeds a predefined threshold value, the smart device may decrease the priority of the service or application and update the priority table. For example, suppose that the predefined threshold value is 30%. When a chat application (that is not started-up by user) occupies 31% of the runtime memory space, the smart device may decrease the priority of the chat application and update the priority table. The smart device may adjust or terminate the chat application according to the updated priority.

The smart device may monitor the service or application in real-time according to a second factor: the smart device monitors the service or application according to the frequency with which the service or application is started-up by the user. When the smart device determines that the frequency with which the user starts-up the service or application is higher than a first predefined value, the smart device may increase the priority of the service or application and update the priority table. For example, suppose that the first predefined value is three times per hour. When the smart device determines that the user has started-up the game application four times within one hour, the smart device determines that the frequency of the service or application being started-up by the user is higher than the first predefined value. The smart device may increase the priority of the game application and update the priority table.

The smart device may monitor the service or application in real-time according to a third factor: the smart device monitors the service or application in real-time according to the foreground operation time of the service or application. When the smart device determines that the foreground operation time of the service or application is shorter than a second predefined value, the smart device may decrease the priority of the service or application and update the priority table. For example, suppose that the second predefined value is 30 minutes. When the smart device determines that the foreground operation time of a game application is 20 minutes, the smart device determines that the foreground operation time of the game application is shorter than the second predefined value. The smart device may decrease the priority of the game application and update the priority table. The smart device may adjust the game application to auto-start limited or may terminate the game application according to the update priority.

The smart device may monitor the service or application in real-time according to a fourth factor: the smart device monitors the service or application in real-time according to the frequency with which the user pays attention to the information notification. When the smart device determines that the frequency with which the user pays attention to the information notification is higher than a third predefined value, the smart device may increase the priority of the service or application that transmits the notification and update the priority table.

The smart device may monitor the service or application in real-time according to a fifth factor: the smart device monitors the service or application in real-time according to the amount of data flow occupied by the service or application that is not started-up by a user. When the smart device determines that the amount of data flow occupied by the service or application that is not started-up by user exceeds a fourth predefined value, the smart device may decrease the priority of the service or application that is not started-up by user and update priority table. The smart device may adjust the service or application to auto-start limited or may terminate the service or application according to the updated priority.

The smart device may monitor the service or application in real-time according to a sixth factor: the smart device monitors the service or application in real-time according to a utility rate of the CPU of the smart device occupied by the service or application that is not started-up by a user. When the utility rate of the CPU occupied by the service or application that is not started-up by a user is greater than a fifth predefined value, the smart device may decrease the priority of the service or application that is not started-up by user and update priority table. The smart device may adjust the service or application to auto-start limited or may terminate the service or application according to the updated priority.

The smart device may monitor the service or application in real-time according to a seventh factor: the smart device monitors the service or application in real-time according to the way to start-up the service or application. When the smart device determines that the service or application is manually started-up by the user, the smart device may increase the priority of the service or application manually started-up by the user and update the priority table.

The smart device may monitor the service or application in real-time according to an eighth factor: the smart device monitors the service or application in real-time according to the way to start-up the service or application. When the smart device determines that the service or application is automatically started-up, the smart device may decrease the priority of the automatically started-up service or application and update the priority table. The smart device may adjust the service or application to auto-start limited or may terminate the service or application according to the updated priority.

The smart device may monitor the service or application in real-time according to a ninth factor: the smart device monitors the service or application in real-time according to the way to start-up the service or application. When the smart device determines that a service or application is relied on by another started-up service or application, the smart device may increase the priority of the service or application being relied on by another started-up service or application and update the priority table.

Selectively, the smart device may also monitor the service or application in real-time according to a combination of the nine factors discussed above. For example, the smart device may monitor the service or application in real-time according to the weighting of the nine factors discussed above to precisely adjust the priority of the service or application according to the actual operation of the user.

In the following paragraphs, the smart device monitors the service or application in real-time according to the combination of the nine factors will be discussed further.

When the smart device detects that an application has never popped-up a notification, or the user usually directly turns off the notifications generated by the application, the smart device may decrease the priority of the application.

When the smart device detects that some service or application operates in the background and barely occupies the CPU of the smart device and only operates in a short time for every period of time, the smart device determines that the service or application does not have to operate in the background and may decrease the priority of the application or terminate the service or application.

When the smart device detects that some service or application receives a broadcast and is started-up anytime, and the service or application occupies the runtime memory space of the smart device or occupies the data flow of the smart device or occupies the CPU of the smart device after being started-up, the smart device decrease the priority of the service or application. The smart device may decrease the priority of the application or terminate the service or application.

When smart device detects some service or application that the user frequently operates begins operating in the background when the user does not operate it, which may cause the service or application to have a decreased priority and risk being terminated, but such service or application should be protected first. The smart device may increase the priority of the service or application to avoid the necessity of starting-up the service or application again when the user wants to operate it.

When the smart device detects that a first application operating in the background is relied on by a second service or application operating in the foreground, the second service or application has to be started-up again if the first application is terminated. In this case, the smart device may increase the priority of the first application to protect the first application.

When the smart device detects that a first service or application receives a broadcast start-up command and the first service or application further starts-up a second service or application, the second service or application was neither started-up by the user nor is required by the user, the smart device may decrease the priority of the second service or application. The smart device may adjust the second service or application to auto-start limited or may terminate the second service or application according to the updated priority.

When the smart device detects that a service or application registers to multiple broadcasts and the service or application will automatically start-up upon receiving the broadcast and then operate in the background, the smart device may decrease the priority of the service or application. The smart device may adjust the service or application to auto-start limited or may terminate the service or application according to the updated priority.

When the smart device detects that a service or application sets multiple times for wake-up events which causes the runtime memory space of the smart device to decrease and the power consumption to increase, the smart device may decrease the priority of the service or application.

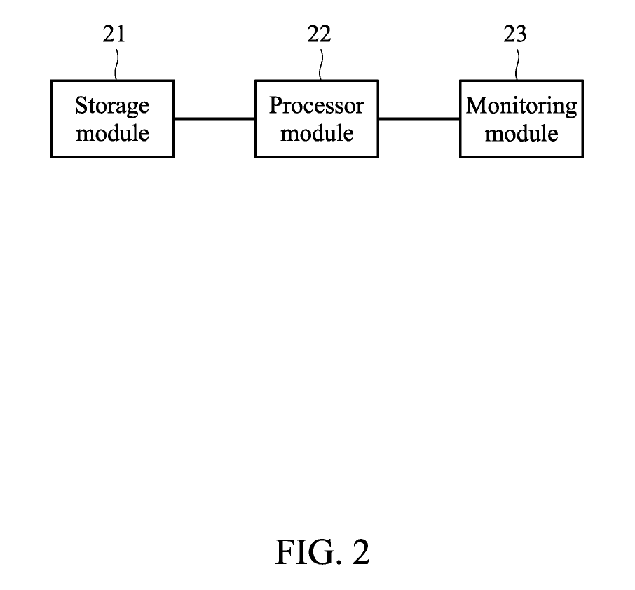

FIG. 2 shows a block diagram of a smart device according to the first embodiment of the invention. The smart device comprises a storage module 21, a processor module 22 and a monitoring module 23. The processor module 22 is coupled to the storage module 21 and the monitoring module 23 is coupled to the storage module 21.

The storage module 21 stores the priority table for services or applications. The processor module 22 obtains the priority table from the storage module 21, obtains the priority corresponding to a service or application according to the priority table and adjusts or terminates the service or application according to the priority corresponding to the service or application. The monitoring module 23 monitors the service or application in real-time to obtain a monitoring result and updates the priority table according to the monitoring result.

The smart device in the second embodiment of the invention is discussed further based on the smart device in the first embodiment of the invention. The monitoring module 23 monitors the service or application in real-time according to the 9 factors (monitoring condition) discussed-above to obtain the monitoring result. In the other embodiments of the invention, it will be readily appreciated by those who are skilled in this technology that the service or application can be monitored according to some more factors, for example, 20 factors, predefined according to the requirements. The monitoring module 23 may monitor the service or application in real-time according to the 20 factors.

The monitoring module 23 may monitor the service or application in real-time according to a first factor: the monitoring module 23 identifies whether the service or application that is started-up by a user. When the amount of runtime memory space occupied by the service or application that is not started-up by a user exceeds a predefined threshold value, the monitoring module 23 may decrease the priority of the service or application and update the priority table. For example, suppose that the predefined threshold value is 30%. When a chat application (that is not started-up by user) occupies 31% of the runtime memory space, the monitoring module 23 may decrease the priority of the chat application and update the priority table. The processor module 22 may adjust the chat application to auto-start limited or terminate the chat application according to the updated priority.

The monitoring module 23 may monitor the service or application in real-time according to a second factor: the monitoring module 23 monitors the service or application according to the frequency of the service or application being started-up by the user. When the monitoring module 23 determines that the frequency with which the user starts-up the service or application is higher than a first predefined value, the monitoring module 23 may increase the priority of the service or application and update the priority table. For example, suppose that the first predefined value is three times per hour. When the monitoring module 23 determines that the user has started-up the game application four times within one hour, the monitoring module 23 determines that the frequency of the service or application being started-up by the user is higher than the first predefined value. The monitoring module 23 may increase the priority of the game application and update the priority table.

The monitoring module 23 may monitor the service or application in real-time according to a third factor: the monitoring module 23 monitors the service or application in real-time according to the foreground operation time of the service or application. When the monitoring module 23 determines that the foreground operation time of the service or application is shorter than a second predefined value, the monitoring module 23 may decrease the priority of the service or application and update the priority table. For example, suppose that the second predefined value is 30 minutes. When the monitoring module 23 determines that the foreground operation time of a game application is 20 minutes, the monitoring module 23 determines that the foreground operation time of the game application is shorter than the second predefined value. The monitoring module 23 may decrease the priority of the game application and update the priority table. The processor module 22 may adjust the game application to auto-start limited or may terminate the game application according to the update priority.

The monitoring module 23 may monitor the service or application in real-time according to a fourth factor: the monitoring module 23 monitors the service or application in real-time according to the frequency with which the user pays attention to the information notification. When the monitoring module 23 determines that the frequency with which the user pays attention to the information notification is higher than a third predefined value, the monitoring module 23 may increase the priority of the service or application that transmits the notification and update the priority table.

The monitoring module 23 may monitor the service or application in real-time according to a fifth factor: the monitoring module 23 monitors the service or application in real-time according to the amount of data flow occupied by the service or application that is not started-up by user. When the monitoring module 23 determines that the amount of data flow occupied by the service or application that is not started-up by user exceeds a fourth predefined value, the monitoring module 23 may decrease the priority of the service or application that is not started-up by user and update priority table. The processor module 22 may adjust the service or application to auto-start limited or may terminate the service or application according to the updated priority.

The monitoring module 23 may monitor the service or application in real-time according to a sixth factor: the monitoring module 23 monitors the service or application in real-time according to a utility rate of the CPU of the smart device occupied by the service or application that is not started-up by a user. When the utility rate of the CPU occupied by the service or application that is not started-up by user is greater than a fifth predefined value, the monitoring module 23 may decrease the priority of the service or application that is not started-up by user and update priority table. The processor module 22 may adjust the service or application to auto-start limited or may terminate the service or application according to the updated priority.

The monitoring module 23 may monitor the service or application in real-time according to a seventh factor: the monitoring module 23 monitors the service or application in real-time according to the way to start-up the service or application. When the monitoring module 23 determines that the service or application is manually started-up by the user, the monitoring module 23 may increase the priority of the service or application manually started-up by the user and update the priority table.

The monitoring module 23 may monitor the service or application in real-time according to an eighth factor: the smart device monitors the service or application in real-time according to the way to start-up the service or application. When the monitoring module 23 determines that the service or application is automatically started-up, the monitoring module 23 may decrease the priority of the automatically started-up service or application and update the priority table. The processor module 22 may adjust the service or application to auto-start limited or may terminate the service or application according to the updated priority.

The monitoring module 23 may monitor the service or application in real-time according to a ninth factor: the monitoring module 23 monitors the service or application in real-time according to the way to start-up the service or application. When the monitoring module 23 determines that a service or application is relied on by another started-up service or application, the monitoring module 23 may increase the priority of the service or application being relied on by another started-up service or application and update the priority table.

Selectively, the monitoring module 23 may also monitor the service or application in real-time according to a combination of the factors discussed above. For example, the monitoring module 23 may monitor the service or application in real-time according to the weighting of multiple factors discussed above to precisely adjust the priority of the service or application according to the actual operation of the user.

In the following paragraphs, the monitoring module 23 monitors the service or application in real-time according to the combination of multiple factors will be discussed further.

When the monitoring module 23 detects that an application has never popped-up a notification or the user usually directly turns off the notifications generated by an application, the monitoring module 23 may decrease the priority of the application.

When the monitoring module 23 detects that some service or application operates in the background and barely occupies the CPU of the smart device and only operates in a short time for every period of time, the monitoring module 23 determines that the service or application does not have to operate in the background and may decrease the priority of the application. The processor module 22 may adjust the service or application to auto-start limited or may terminate the service or application according to the updated priority.

When the monitoring module 23 detects that some service or application receives a broadcast and is started-up anytime, and the service or application occupies the runtime memory space of the smart device or occupies the data flow of the smart device or occupies the CPU of the smart device after being started-up, the monitoring module 23 decrease the priority of the service or application. The processor module 22 may adjust the service or application to auto-start limited or may terminate the service or application according to the updated priority.

When the monitoring module 23 detects some service or application that the user frequently operates begins operating in the background when the user does not operate it, which may cause the service or application to have a decreased priority and risk being terminated, but such service or application should be protected first. The monitoring module 23 may increase the priority of the service or application to avoid the necessity of starting-up the service or application again when the user wants to operate it.

When the monitoring module 23 detects that a first application operating in the background is relied on by a second service or application operating in the foreground, the second service or application has to be started-up again if the first application is terminated. In this manner, the monitoring module 23 may increase the priority of the first application to protect the first application.

When the monitoring module 23 detects that a first service or application receives a broadcast start-up command and the first service or application further starts-up a second service or application, the second service or application is neither started-up by user nor is required by the user. The monitoring module 23 may decrease the priority of the second service or application. The processor module 22 may adjust the second service or application to auto-start limited or may terminate the second service or application according to the updated priority.

When the monitoring module 23 detects that a service or application registers to multiple broadcasts and the service or application will automatically start-up upon receiving the broadcast and then operate in the background, the monitoring module 23 may decrease the priority of the service or application. The processor module 22 may adjust the service or application to auto-start limited or may terminate the service or application according to the updated priority.

When the monitoring module 23 detects that a service or application sets multiple times for wake-up events which causes the runtime memory space of the monitoring module 23 to decrease and the power consumption to increase since the smart device cannot enter a sleep mode or a deep sleep mode, the monitoring module 23 may decrease the priority of the service or application. The processor module 22 may adjust the service or application to auto-start limited or may terminate the service or application according to the updated priority.

In summary, in the embodiments of the invention, the smart device may obtain the corresponding priority of the service or application according to the priority table; adjust or terminate the service or application according to the priority thereof; monitor the service or application in real-time to obtain a monitoring result; and update the priority table according to the monitoring result. The smart device may achieve self-learning by observing the actual operation of the user; the smart device may monitor the service or application in real-time to obtain a monitoring result; update the priority table according to the monitoring result; and adjust or terminate the service or application according to the updated priority to prevent the time taken for the smart device to start up the service or the application from getting longer and longer and improve the performance of the smart device and increase the amount of saved-power of the smart device.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for managing a service or application for a smart device, comprising:
obtaining a priority corresponding to the service or application according to a priority table;
adjusting or terminating the service or application according to the priority;
monitoring the service or application in real-time to obtain a monitoring result; and
updating the priority table according to the monitoring result.

2. The method as claimed in claim 1, wherein the step of adjusting or terminating the service or application according to the priority further comprises:
when the priority of the service or application is lower than a predetermined value, adjusting the service or the application to auto-start limited.

3. The method as claimed in claim 1, wherein the step of adjusting or terminating the service or application according to the priority further comprises:
when an amount of runtime memory space of the smart device occupied by started-up service(s) or application(s) exceeds a threshold value,
terminating a service or application having a low priority among the started-up service(s) or application(s).

4. The method as claimed in claim 1, wherein the step of monitoring the service or application in real-time to obtain a monitoring result further comprises:
monitoring the service or application according to a frequency of the service or application being started-up by a user; and
when the frequency is higher than a first predefined value, increasing the priority of the service or application and updating the priority table.

5. The method as claimed in claim 1, wherein the step of monitoring the service or application in real-time to obtain a monitoring result further comprises:
monitoring the service or application in real-time according to a foreground operation time of the service or application; and
when the foreground operation time of the service or application is shorter than a second predefined value, decreasing the priority of the service or application and updating the priority table.

6. The method as claimed in claim 1, wherein the step of monitoring the service or application in real-time to obtain a monitoring result further comprises:
monitoring the service or application in real-time according to a frequency with which a user pays attention to an information notification of the service or application; and
when the frequency with which the user pays attention to the information notification of the service or application is higher than a third predefined value, increasing the priority of the service or application that transmits the information notification and updating the priority table.

7. The method as claimed in claim 1, wherein the step of monitoring the service or application in real-time to obtain a monitoring result further comprises:
monitoring the service or application in real-time according to an amount of data flow occupied by the service or application that is not started-up by a user; and
when the amount of data flow occupied by the service or application that is not started-up by the user exceeds a fourth predefined value, decreasing the priority of the service or application that is not started-up by the user and updating priority table.

8. The method as claimed in claim 1, wherein the step of monitoring the service or application in real-time to obtain a monitoring result further comprises:
monitoring the service or application in real-time according to a utility rate of a CPU of the smart device occupied by the service or application that is not started-up by a user; and
when the utility rate of the CPU occupied by the service or application that is not started-up by the user is greater than a fifth predefined value, decreasing the priority of the service or application that is not started-up by the user and updating the priority table.

9. The method as claimed in claim 1, wherein the step of monitoring the service or application in real-time to obtain a monitoring result further comprises:
monitoring the service or application in real-time according to a way to start-up the service or application; and
when the service or application is manually started-up by a user, increasing the priority of the service or application manually started-up by the user and updating the priority table.

10. The method as claimed in claim 1, wherein the step of monitoring the service or application in real-time to obtain a monitoring result further comprises:
monitoring the service or application in real-time according to a way to start-up the service or application; and
when the service or application is automatically started-up, decreasing the priority of the service or application that is automatically started-up and updating the priority table.

11. The method as claimed in claim 1, wherein the step of monitoring the service
monitoring the service or application in real-time according to a way to start-up the service or application; and
when the service or application is relied on by another started-up service or application, increasing the priority of the service or application being relied on by another started-up service or application and updating the priority table.

12. A smart device, comprising:
a storage module, storing a priority table for services or applications;
a processor module, coupled to the storage module, obtaining a priority of a service or application according to the priority table and adjusting or terminating the service or application according to the priority; and
a monitoring module, coupled to the storage module, monitoring the service or application in real-time to obtain a monitoring result and updating the priority table according to the monitoring result.

13. The smart device as claimed in claim 12, wherein when the priority of the service or application is lower than a predetermined value, the processor module adjusts the service or the application to auto-start limited.

14. The smart device as claimed in claim 12, wherein when the processor module determines that an amount of runtime memory space of the smart device occupied by started-up service(s) or application(s) exceeds a threshold value, the processor module terminates a service or application having a low priority among the started-up service(s) or application(s).

15. The smart device as claimed in claim 12, wherein the monitoring module monitors the service or application according to a frequency of the service or application the monitoring module increases the priority of the service or application and updates the priority table.

16. The smart device as claimed in claim 12, wherein the monitoring module monitors the service or application in real-time according to a foreground operation time of the service or application, and when the foreground operation time of the service or application is shorter than a second predefined value, the monitoring module decreases the priority of the service or application and updates the priority table.

17. The smart device as claimed in claim 12, wherein the monitoring module monitors the service or application in real-time according to a frequency with which a user pays attention to an information notification of the service or application, and when the frequency with which the user pays attention to the information notification of the service or application is higher than a third predefined value, the monitoring module increases the priority of the service or application that transmits the information notification and updates the priority table.

18. The smart device as claimed in claim 12, wherein the monitoring module monitors the service or application in real-time according to an amount of data flow occupied by the service or application that is not started-up by a user, and when the amount of data flow occupied by the service or application that is not started-up by the user exceeds a fourth predefined value, the monitoring module decreases the priority of the service or application that is not started-up by the user and updates priority table.

19. The smart device as claimed in claim 12, wherein the monitoring module monitors the service or application in real-time according to the service or application that is not started-up by a user and occupies a utility rate of a CPU of the smart device, and when the utility rate of the CPU occupied by the service or application that is not started-up by the user is greater than a fifth predefined value, the monitoring module decreases the priority of the service or application that is not started-up by the user and updates the priority table.

20. The smart device as claimed in claim 12, wherein the monitoring module monitors the service or application in real-time according to a way to start-up the service or application, and when the service or application is manually started-up by a user, the monitoring module increases the priority of the service or application manually started-up by the user and updates the priority table.

21. The smart device as claimed in claim 12, wherein the monitoring module monitors the service or application in real-time according to a way to start-up the service or application, and when the service or application is automatically started-up, the monitoring module decreases the priority of the service or application that is automatically started-up and updates the priority table.

22. The smart device as claimed in claim 12, wherein the monitoring module monitors the service or application in real-time according to a way to start-up the service or application, and when the service or application is relied on by another started-up service or application, the monitoring module increases the priority of the service or application being relied on by another started-up service or application and updates the priority table.
